(19) United States
(12) Patent Application Publication
(10) Pub. No.: US 2017/0280757 A1
(43) Pub. Date: Oct. 5, 2017

(54) Umami-Enhanced Food Product and Method of Enhancing the Umami Taste of Food Products

(71) Applicants: Frito-Lay North America, Inc., Plano, TX (US); Regents of the University of Minnesota, Minneapolis, MN (US)

(72) Inventors: Stefan K. BAIER, Hartsdale, NY (US); Juan Ignacio CORUJO-MARTINEZ, Frisco, TX (US); Auroni MAJUMDAR, New York, NY (US); Devin G. PETERSON, St. Paul, MN (US); Rajesh Venkata POTINENI, Union, NJ (US); Liyun ZHANG, Bloomington, IN (US)

(21) Appl. No.: 15/088,560

(22) Filed: Apr. 1, 2016

(51) Int. Cl. A23L 27/22; A23L 27/00

(52) U.S. Cl. CPC A23L 27/22; A23L 27/88; A23V 2002/00

(57) ABSTRACT

A pyroglutamic acid composition comprising pyroglutamic acid enhances the umami sensation of food products when topically applied. The pyroglutamic acid may be derived from a food product such as a tuber product or potato. The pyroglutamic acid may be in the form of L-pyroglutamic acid, D-pyroglutamic acid, or mixtures thereof. Topical addition of pyroglutamic acid in an amount of between about 300 to about 12,000 ppm onto a food product enhances both the salty and umami taste perceptions simultaneously. Other seasonings may also be simultaneously applied to the food product as part of the pyroglutamic acid composition. Alternatively, additional seasoning may be applied apart from the addition of the pyroglutamic acid in a separate step.

### BACKGROUND OF THE INVENTION

### Technical Field

The present invention relates to food products having an enhanced umami sensation. In particular, the present invention relates to topical application of a pyroglutamic acid composition onto food products.

### Description of Related Art

The food industry generally recognizes five basic tastes: sweet, salty, sour, bitter, and umami, which imparts a “brothy”, “meaty”, or “savory” taste. The umami taste has been discovered in a wide range of foods (including meat, seafood, and soy sauce, for example) and a number of amino acids believed to impart umami characteristics exist. There remains a further need for compounds that provide the umami sensation. There is also a need for more umami-enhancing methods to enrich the salty taste and improve overall flavor perception of savory food snacks.

### SUMMARY OF THE INVENTION

Provided herein is an umami-enhancing flavoring composition for improving upon the umami taste profile and/or sensation of food products. More specifically, a pyroglutamic acid composition provides for an umami-enhancing compound and provides enhanced salty and umami tastes when topically applied onto a snack food product.

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

A ready-to-eat food product comprises a topically applied amount of an added pyroglutamic acid composition, the pyroglutamic acid composition comprising pyroglutamic acid and providing an umami-enhanced flavor. In various embodiments, the pyroglutamic acid is in the form of L-pyroglutamic acid, D-pyroglutamic acid or mixtures thereof. In any of the above embodiments, the food product may comprise between about 300 to about 12,000 ppm added pyroglutamic acid to achieve an umami-enhancing effect. In any of the above embodiments, the pyroglutamic acid is derived from a tuberous food product. In any of the above embodiments, the food product is a snack food product substantially based on one or more of potato, tortilla, oats, corn, cornmeal, flour, rice, and cereal. In various above embodiments, the snack food comprises a moisture content of less than about 4%. In any of the above embodiments, the pyroglutamic acid is in a solid form comprising crystals, salts, powders, flakes, agglomerates, or mixtures thereof.

A method for enhancing the umami taste of a food product comprises the step of topically applying the pyroglutamic acid composition onto a food product, the pyroglutamic acid composition comprising pyroglutamic acid and providing an umami-enhanced flavor.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, objectives, and advantages thereof will be best understood by reference to the following detailed description of illustrative embodiments when read in conjunction with the accompanying drawings, wherein:

FIG. 1 is a graphical representation of saltiness intensity ratings provided by a trained panel.

FIG. 2 is a graphical representation of umami intensity ratings provided by a trained panel.

FIG. 3 is a graphical representation of the potato chip flavor intensity rating provided by a trained panel.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified together with the phrase. Several embodiments for umami-enhancing flavoring composition and methods for making a food snack with enhanced umami taste will now be described.

A ready-to-eat food product comprises a topical amount of added pyroglutamic acid composition, the pyroglutamic acid composition comprising pyroglutamic acid or a salt thereof and providing an umami-enhanced flavor. In some embodiments, the pyroglutamic acid composition consists of pyroglutamic acid or a salt thereof. As used herein, pyroglutamic acid refers to any enantiomer of pyroglutamic acid (i.e., L-pyroglutamatic acid (L-PGA) and D-pyroglutamic acid (D-PGA)), any salt of pyroglutamic acid (i.e., monosodium L-pyroglutamate (L-MSpG) and monosodium D-pyroglutamate (D-MSpG)), and any combination of these. In one embodiment, pyroglutamic acid of the pyroglutamic acid composition comprises one or more of monosodium L-pyroglutamate (L-MSpG) and monosodium D-pyroglutamate (D-MSpG). The pyroglutamic acid of the pyroglutamic acid composition may also comprise L-pyroglutamic acid and D-pyroglutamic acid, and any mixture of L-pyroglutamic acid and D-pyroglutamic acid in another embodiment. Furthermore, a “salt form thereof” (or a “salt form of a pyroglutamic acid”) is a food-grade salt acceptable or suitable for ingestion or consumption, for example a sodium salt, a potassium salt, a calcium salt, a zinc salt, a magnesium salt, an ammonium salt, an alkyl ammonium salt and the like.

When used on food products, the topical addition of the pyroglutamic acid composition improves upon the overall flavor intensity and taste profile. Pyroglutamic acid compounds of the pyroglutamic acid composition are derived from a tuberous food product in one embodiment. In one embodiment, the tuberous food product is a potato. Other suitable forms of the pyroglutamic acid compound as described herein are readily commercially available.

As used herein, a ready-to-eat food product is a food product that is ready to consume without any additional cooking or treatment steps for ingesting by a consumer. In one embodiment, the ready-to-eat food product is a snack food product substantially based or derived from one or more of potato, tortilla, oats, corn, cornmeal, flour, rice, and cereal. In one embodiment, the snack food product is a shelf-stable product with a moisture content of less than about 4%. In one embodiment, the ready-to-eat food product comprises a moisture content of between about 2% to about 4%. In one embodiment, the ready-to-eat food product comprises a moisture content of between about 3% to about 4%. The ready-to-eat food product may be obtained or prepared by any means known in the art. In one embodiment, the ready-to-eat food product is a shelf stable snack food product and may be prepared, for example, by forming, sheeting, and/or cutting a dough into snack-sized portions, or by cutting or slicing vegetable or fruit products into snack sized portions; followed by baking or frying the snack sized portions into shelf-stable snack foods having the aforementioned moisture content.

In various embodiments, the ready-to-eat food product comprises between about 300 ppm to about 12,000 ppm added pyroglutamic acid or salt thereof (e.g., in any form as described herein, in amounts of, for example, about 300 ppm, about 350 ppm, about 400 ppm, about 450 ppm, about 500 ppm, about 550 ppm, about 600 ppm, about 650 ppm, about 700 ppm, about 750 ppm, about 800 ppm, about 850 ppm, about 900 ppm, about 950 ppm, about 1,000 ppm, about 1,500 ppm, about 2,000 ppm, about 2,500 ppm, about 3000 ppm, about 3,500 ppm, about 4,000 ppm, about 4,500 ppm, about 5,000 ppm, about 5,500 ppm, about 6,000 ppm, about 6,500 ppm, about 7,000 ppm, about 7,500 ppm, about 8,000 ppm, about 8,500 ppm, about 9,000 ppm, about 9,500, about 10,000 ppm, about 10, 500 ppm, about 11,000 ppm, about 11,500 ppm, about 12,000 ppm, or any ranges between these recited concentrations). The exact concentration may vary according to the ready-to-eat product and desired effect. The skilled person can adjust within these ranges for a given ready-to-eat food product to achieve a desired effect based on the disclosure herein. In one embodiment, the ready-to-eat food product comprises between about 300 to about 6,000 ppm added pyroglutamic acid.

In one embodiment, the ready-to-eat food product comprises between about 500 to about 5,000 ppm added L-pyroglutamic acid. In one embodiment, the ready-to-eat food product comprises between about 500 to about 4,000 ppm added L-pyroglutamic acid. In one embodiment, the ready-to-eat food product comprises between about 700 to about 3,000 ppm added L-pyroglutamic acid. In one embodiment, the ready-to-eat food product comprises between about 700 to about 2,400 ppm added L-pyroglutamic acid. In one embodiment, the ready-to-eat food product comprises between about 700 to about 1,500 ppm added L-pyroglutamic acid. In one embodiment, the ready-to-eat food product comprises between about 1,000 to about 2,000 ppm added L-pyroglutamic acid.

In one embodiment, the ready-to-eat food product comprises between about 300 ppm to about 3,000 ppm added D-pyroglutamic acid. In one embodiment, the ready-to-eat food product comprises between about 300 ppm to about 2,000 ppm added D-pyroglutamic acid. In one embodiment, the ready-to-eat food product comprises between about 300 ppm to about 1,100 ppm added D-pyroglutamic acid. In one embodiment, the ready-to-eat food product comprises between about 400 ppm to about 1,100 ppm added D-pyroglutamic acid. In one embodiment, the ready-to-eat food product comprises between about 400 ppm to about 700 ppm added D-pyroglutamic acid. In one embodiment, the ready-to-eat food product comprises between about 700 ppm to about 900 ppm added D-pyroglutamic acid.

In some embodiments, the pyroglutamic acid may comprise a mixture of its enantiomeric forms. In one embodiment, the pyroglutamic acid of the ready-to-eat food product comprises between about 300 to about 7,000 ppm of an added mixture of L-pyroglutamic acid and D-pyroglutamic acid. In one embodiment, the pyroglutamic acid of the ready-to-eat food product comprises between about 300 to about 4,000 ppm of an added mixture of L-pyroglutamic acid and D-pyroglutamic acid. In one embodiment, the pyroglutamic acid of the ready-to-eat food product comprises between about 500 to 4,000 ppm of an added mixture of L-pyroglutamic acid and D-pyroglutamic acid. In one embodiment, the pyroglutamic acid of the ready-to-eat food product comprises between about 1,000 to less than 4,000 ppm of an added mixture of L-pyroglutamic acid and D-pyroglutamic acid. Mixtures of L-pyroglutamic acid and D-pyroglutamic acid may generally comprise L-pyroglutamic acid in a concentration greater than the D-pyroglutamic acid. In one embodiment, the ratio of L-pyroglutamic acid to D-pyroglutamic acid is between about 2:1 to 6:1. In one embodiment, the ratio of L-pyroglutamic acid to D-pyroglutamic acid is between about 3:1 to 5:1.

In embodiments where the snack food product comprises a potato food base, the pyroglutamic acid composition for topical addition to the potato food base further comprises salt and an anticaking agent, including without limitation silicon dioxide. A potato food base is a potato snack food such as a chip derived in whole or in part from one or more of a potato, potato flakes, or potato flour, for example. Tables 1-2 provide a number of embodiments (shelf-stable chip products A-B) for the food product having a potato food base.

TABLE 1
Sample potato product A

| Compound | Composition % |
|---|---|
| Salt | 1.45%-1.48% |
| L-MSpG | 0.07%-0.15% |
| Silicon Dioxide | 0.30% |
| PC base | Remaining % to total 100% |

TABLE 2
Sample potato product B

| Compound | Composition % |
|---|---|
| Salt | 1.48%-1.49% |
| D-MSpG | 0.04%-0.07% |
| Silicon Dioxide | 0.30% |
| PC base | Remaining % to total 100% |

The pyroglutamic acid composition described herein may optionally comprise one or more topically added seasonings for one single topping and single topping step, further described below. Alternatively, the food product may comprise a separate layer or coating comprising one or more additional seasonings typical of snack food products. Thus, the pyroglutamic acid composition may comprise or consist of pyroglutamic acid compound. The pyroglutamic acid may be topically added either alone or together with other optional seasonings onto the food product.

The pyroglutamic acid composition described herein may be topically added onto a food product in solid form. The solid form may comprise one or more of salts, crystals, powders, flakes, agglomerates, or mixtures thereof, for example. In one embodiment, the solid form is selected from the group consisting of salts, crystals, powders, flakes, agglomerates or mixtures thereof.

The method of enhancing the umami taste of a food product comprises the step of topically applying a pyroglutamic acid composition, as described above, onto a food product, the pyroglutamic acid composition comprising pyroglutamic acid and providing an umami-enhanced flavor effect. In one embodiment, the pyroglutamic acid composition comprises one or more optional seasonings such as salt or sodium chloride (for example) together with the pyroglutamic acid. In one embodiment, the pyroglutamic acid composition consists of pyroglutamic acid. In some embodiments, the method of enhancing the umami taste of a food product thus comprises an additional topical application step. In embodiments comprising a potato chip base as the food product, for example, salt and an anticaking agent should be added separately, either before or after the pyroglutamic acid composition, when the pyroglutamic acid composition consists of pyroglutamic acid. In one embodiment, the step of topically applying the pyroglutamic acid composition comprises application of the composition onto the surface of a warm food product, the warm food product comprising a temperature of about 130° F. to about 160° F.

To confirm the umami-enhancing activity of the pyroglutamic acid composition, D-pyroglutamic acid was obtained from TCI Co, Ltd. L-glutamic acid and L-pyroglutamic acid were purchased from Sigma Aldrich, Inc. The compounds were applied topically to various samples of potato chips to examine their effect on overall taste and flavor profile at a level described below. A panel of eight judges (4 males and 4 females) evaluated the salty and umami intensity of the pyroglutamic acid in aqueous solutions. Prior to the test, all panelists participated in 12 training sessions of approximately 1 hour over a period of 4 weeks. Panelists were trained on a 10-point scale using a salty reference (0.35% NaCl) and an umami reference (0.225% MSG+0.2% L-MSpG+0.025% D-MSpG). The compounds of interest (Table 3) were evaluated for salty and umami intensity in duplicate. All samples were prepared the morning of the evaluation by adding L-MSpG (0.41 g/L) or D-MSpG (0.41 g/L) or L-monosodium glutamate (MSG) (0.46 g/L) or D-MSG (0.46 g/L) in a tasting solution containing 1.73 g/L sodium (equivalent to 4.40 g/L NaCl). The pH of each sample was then adjusted to 6.5±0.5. Samples were assigned three-digit codes and presented in randomized order. Panelists used PTFE droppers to dispense 2 ml of solution on the center of their tongue and were asked to rate the umami and salty intensity of the samples using a linear 10-point scale. Water, unsalted crackers and apples slices were used as palate cleansers.

Panelists evaluated the saltiness, umami and potato chip flavor intensity of two samples of potato chips: 1) control chips without pyroglutamic acid and 2) potato chips with topical treatment of pyroglutamic acid. For sample preparation, potato chips were divided into two batches of 60 g±0.1 g. Each of the potato chip batches was placed in a polyethylene food-grade transparent bag. The chips were crushed to ≦0.5 mm in diameter and 0.205 g of L-monosodium pyroglutamate (L-MSpG), and 0.036 g of D-monosodium pyroglutamate (D-MSpG), powder was applied topically. Both of the control and topically treated sample bags were sealed, flushed with nitrogen, and shaken at 285 rpm for 1 hour (30 minutes each side).

The panelists were presented with the three digit coded samples in a randomized order. They were asked to masticate each potato chip sample (2 g) for 20 seconds and then swallow. Panelists rated the intensity of saltiness, umami and potato chip flavor at the following time points: 5 s, 10 s, 15 s, 20 s, 30 s, and 45 s. Each sample was evaluated in triplicate, with the panelists evaluating one taste attribute each time. Ratings were based on a 10-point linear scale, with references for salty and umami as described previously. An unsalted potato chip sample was used as a reference for potato chip flavor, intensity 5.

The salt compounds of pyroglutamic acid (L- and D-MSpG) were tested for umami enhancing activity using a sodium chloride (NaCl) tasting solution. Both L-MSG and D-MSG were also tested for comparison. To make direct comparisons, samples were prepared at isomolar levels in solution for each compound (L-MSpG or D-MSpG or L-MSG or D-MSG) at equivalent sodium levels. A concentration of L-MSpG (0.41 g/L) or D-MSpG (0.41 g/L) or L-MSG (0.46 g/L) or D-MSG (0.46 g/L) in a tasting solution containing 1.73 g/L sodium (equivalent to 4.40 g/L NaCl) were prepared and the panelists rated the salty and umami intensity of each mixture, see Table 1.

TABLE 3
Mean salty and umami ratings of NaCl solution with and without test
compounds that at the concentration of D-MSpG in human saliva.^{a}

| Samples | Salty | Umami |
|---|---|---|
| 4.40 g/L NaCl^{b} | 6.09a | 0.37d |
| 4.24 g/L NaCl + 0.46 g/L D-MSG | 6.09a | 0.94c |
| 4.24 g/L NaCl + 0.41 g/L L-MSpG | 6.03a | 1.92b |
| 4.24 g/L NaCl + 0.41 g/L D-MSpG | 5.91ab | 1.50b |
| 4.24 g/L NaCl + 0.46 g/L L-MSG | 5.47bc | 3.37a |

^{a}Mean ratings with letters in common do not differ significantly (5% significance level).
^{b}The sodium level is adjusted to be the same between samples.

Both of the L- and D-monosodium pyroglutamate were found to have higher umami intensity when compared to the control salt solution (4.40 g/L NaCl). L-MSpG with NaCl, the more abundant isomer, received the highest intensity rating. The L-MSG sample, which is known to have strong umami taste, received the highest rating for umami intensity but interestingly the salty intensity of that solution was suppressed and was found to be significantly lower than the control solution. This indicates an advantageous sensory attribute of MSpG and lends strength to its potential as a flavor enhancer. In snack foods comprising potato, samples comprising MSpG also produced an enhanced potato flavor not found using MSG.

A recombination study was also conducted in order to evaluate the intensity of all the umami compounds to evaluate their contribution to the overall perceived umami taste in potato chips. The recombinant was prepared by adding appropriate amounts of D-MSG, L-MSG, D-MSpG and L-MSpG in a salt tasting solution and was then compared with control potato chips. Addition of all compounds and salt was based on amounts quantified in saliva after consumption of the control potato chips. Solutions were adjusted at pH 6.5, using sodium carbonate as the base. The results are shown in Table 4 and indicated that the intensity of salty and umami tastes were not significantly different between the recombinant mixture and the control potato chips. This validates the significance of the pyroglutamic acid compounds described herein and their overall contribution to the savory/umami profile of food products such as potato chips.

TABLE 4
Mean salty and umami ratings of the recombination
model and the control potato chips sample

| Samples | Salty | Umami |
|---|---|---|
| Mixture^{a} | 5.56a | 3.94a |
| Potato Chips | 6.00a | 3.38a |

^{a}Mixture consisted of 2.48 g/L of L-MSpG, 0.41 g/L of D-MSpG, 0.95 g/L of L-MSG, 0.08 g/L of D-MSG and 1.73 g/L of sodium.

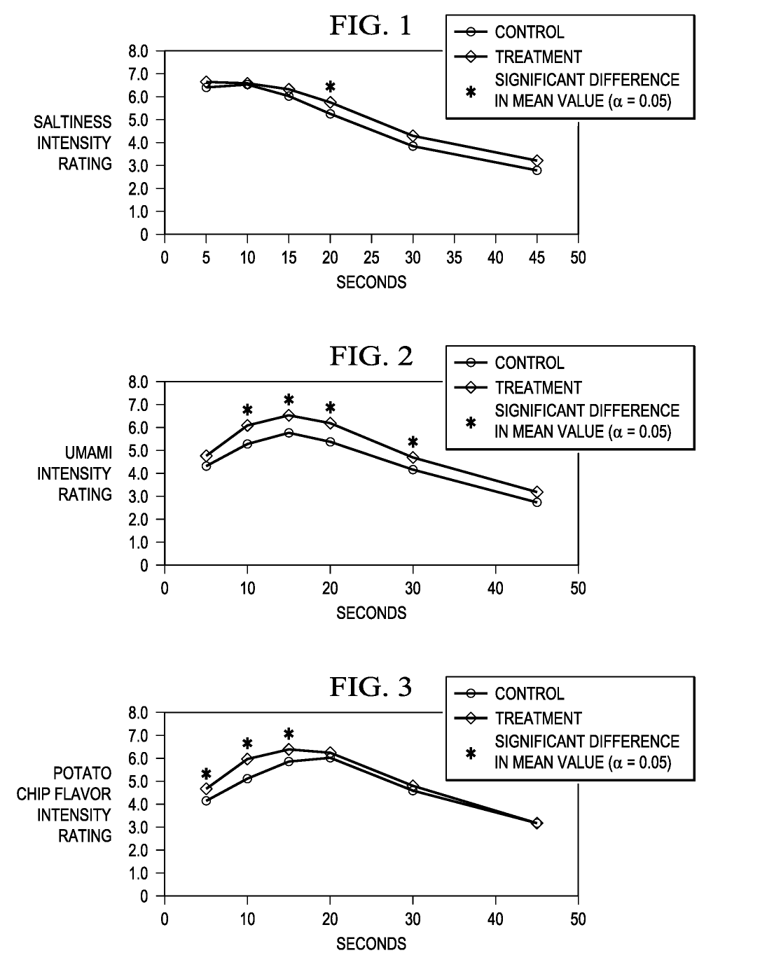

Time intensity study results can be found in FIGS. 1A-1C, in which the effect of the pyroglutamic acid was assessed through topical application to potato chips. Panelists evaluated the saltiness, umami, and overall potato flavor intensity by time-intensity sensory methods. The D-MSpG and L-MSpG were added and commercially available potato chips were used as a control. As depicted in FIGS. 1A-1C, the application of the umami-enhancing pyroglutamic acid compounds on the potato chips significantly enhanced the intensity of saltiness, umami, and potato chip flavor intensity.

Review of the temporal profile indicated when the umami-enhancing compounds were added, the saltiness intensity increased during the later stages of mastication. The saltiness enhancement was significant at about 20 seconds. For umami perception, both samples reached maximum at 15 second but the sample with added pyroglutamic acid compounds had significantly higher umami intensity throughout the mastication process and after swallowing except for the initial and final time point. The intensity of the potato chip flavor attribute closely followed the observed trend for umami where the maximum rating was perceived at 15-20 seconds. Interestingly, the treated sample (with topically applied Pyroglutamic acid) was reported to have higher potato chip flavor intensity during the initial stages of the mastication process (5 sec, 10 sec, 15 second time points) while after swallowing (20 seconds) the difference between samples became less apparent.

The food product and method disclosed herein may be suitably practiced in the absence of any element, limitation, compound or step that is not specifically disclosed herein. Consequently, specific snack food embodiments described herein may be obtained in the absence of any component or compound not specifically described herein. Thus, the ready-to-eat food products with enhanced umami taste, and methods for making same, described herein may consist of (only) those listed components, compounds or steps as described above.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A ready-to-eat food product comprising a topical amount of added pyroglutamic acid composition, said pyroglutamic acid composition comprising pyroglutamic acid and providing an umami-enhanced flavor.

2. The ready-to-eat food product of claim 1 wherein the pyroglutamic acid composition comprises pyroglutamic acid in the form of L-pyroglutamic acid, D-pyroglutamic acid, or mixtures thereof.

3. The ready-to-eat food product of claim 2 wherein the food product comprises between about 300 to about 12,000 ppm pyroglutamic acid.

4. The ready-to-eat food product of claim 1 wherein the pyroglutamic acid is derived from a tuberous food product.

5. The ready-to-eat food product of claim 1 wherein the food product is a snack food product, wherein the snack food product is substantially based on one or more of: potato, tortilla, oats, corn, cornmeal, flour, rice, and cereal.

6. The ready-to-eat food product of claim 5 wherein the snack food comprises a moisture content of less than about 4%.

7. The ready-to-eat food product of claim 1 wherein the pyroglutamic acid composition is in solid form, said solid form comprising crystals, salts, powders, flakes, agglomerates, or mixtures thereof.

8. The ready-to-eat food product of claim 1 further comprising one or more topically added seasonings.

9. The ready-to-eat food product of claim 1 comprising a potato food base, and the topically added pyroglutamic acid composition further comprising salt and an anticaking processing aid.

10. The ready-to-eat food product of claim 1 comprising between about 500 to about 5,000 ppm L-pyroglutamic acid.

11. The ready-to-eat food product of claim 1 comprising between about 300 ppm to about 3,000 ppm D-pyroglutamic acid.

12. The ready-to-eat food product of claim 1 comprising between about 300 to about 7,000 ppm of a mixture of L-pyroglutamic acid and D-pyroglutamic acid.

13. The ready-to-eat food product of claim 1 wherein the pyroglutamic acid composition comprises a ratio of L-pyroglutamic acid to D-pyroglutamic acid in an amount of between about 2:1 to 6:1.

14. A method of enhancing the umami taste of a food product, the method comprising the step of topically applying a pyroglutamic acid composition onto a surface of a ready-to-eat food product, said pyroglutamic acid composition comprising pyroglutamic acid and providing an umami-enhanced flavor.

15. The method of claim 14 wherein the pyroglutamic acid is in the form of L-pyroglutamic acid, D-pyroglutamic acid, or mixtures thereof.

16. The method of claim 14 wherein the pyroglutamic acid composition comprises between about 300 to about 12,000 ppm pyroglutamic acid.

17. The method of claim 15 wherein the pyroglutamic acid is derived from a tuberous food product.

18. The method of claim 14 wherein the pyroglutamic acid composition is in solid form, said solid form comprising crystals, salts, powders, flakes, agglomerates, or mixtures thereof.

19. The method of claim 14 wherein the ready-to-eat food product is substantially based on one or more of: potato, tortilla, oats, corn, cornmeal, flour, rice, and cereal, and wherein the ready-to-eat food product comprises a moisture content of less than about 4%.

20. The method of claim 14 wherein the pyroglutamic acid composition comprises a ratio of L-pyroglutamic acid to D-pyroglutamic acid in an amount of between about 2:1 to 6:1.
